(19) United States
(12) Patent Application Publication
(10) Pub. No.: US 2025/0175927 A1
(43) Pub. Date: May 29, 2025

(54) GEOFENCING NETWORK ACCESS FOR FIXED WIRELESS ACCESS DEVICES

(71) Applicant: T-Mobile USA, Inc., Bellevue, WA (US)

(72) Inventor: MUHAMMAD TAWHIDUR RAHMAN, Bellevue, WA (US)

(21) Appl. No.: 18/520,268

(22) Filed: Nov. 27, 2023

(51) Int. Cl. H04W 64/00; H04W 4/021; H04W 48/16; H04W 60/06

(52) U.S. Cl. CPC H04W 64/00; H04W 4/021; H04W 48/16; H04W 60/06

(57) ABSTRACT

Described herein are methods and systems for determining a user equipment (UE) location of a UE, wherein a UE type of the UE is fixed wireless access. The methods and systems further allow or deny a connection of the UE to a telecommunications network based on geofencing logic applied to at least one of the UE location, the UE type, and a UE identifier of the UE. In some implementations, the methods and systems may allow or deny the connection regardless of the UE location, instead using the UE type and an allow list of UEs permitted to connect to a base station.

### BACKGROUND

Home and business Internet in the past have been fixed to a location. Internet providers send routers for use inside those fixed locations, and the routers often connect to the Internet through a physical mechanism, such as an Ethernet or cable. Because that physical mechanism is required for Internet connectivity, those routers are not usable outside their intended locations.

Internet and network connectivity are increasingly being provided through mobile network operators (MNOs) with wireless access widely available in many locations. MNOs already have an infrastructure for connectivity through base stations and other wireless access points and, to deliver even better performance, provide fixed wireless access (FWA) devices for in-home or in-business use. These FWA devices may be special purpose devices or user equipment (UE) configured to act as FWA. Other UEs and in-home/in-business devices may connect to a telecommunications network of an MNO through the FWA devices and through base stations that the FWA devices are connecting to.

FWA devices are intended for use in a specific location-because of the higher performance delivered, use of FWA devices in other locations can cause impact to performance and connectivity of other users of the MNO's telecommunication network.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is an overview diagram of a UE with a UE type of FWA attempting connection to base stations at different locations, the different locations including one location inside a geofence, where connection is allowed, and other locations outside the geofence, where connection is denied.

FIG. 2 is a schematic diagram of a UE having a UE type of FWA, the UE having one or more components for determining a UE location, for communicating with a base station to establish a connection through the base station to a telecommunications network, and for communicating with other UEs that are using the UE as a FWA device for connecting to the telecommunications network.

FIG. 3 is a schematic diagram of a base station with geofencing logic to implement a geofence for a UE, where the UE type is FWA, and with components for allowing or denying connection of UEs to the base station based on the geofencing logic and for communicating with the UEs and a core network.

FIG. 4 is a flow diagram of an illustrative process for allowing or denying a connection between a UE and a base station based on at least one of a UE location, a UE identifier, or a UE type, where the UE type is FWA.

FIG. 5 is a flow diagram of an illustrative process for allowing or denying a connection between a UE and a base station based on a UE type, where the UE type is FWA, and an allow list of UEs permitted to connect to the base station.

### DETAILED DESCRIPTION

This disclosure is directed in part to methods and systems for determining a user equipment (UE) location of a UE, wherein a UE type of the UE is fixed wireless access (FWA). The methods and systems further allow or deny a connection of the UE to a telecommunications network based on geofencing logic applied to at least one of the UE location, the UE type, and a UE identifier of the UE. In some implementations, the methods and systems may allow or deny the connection regardless of the UE location, instead using the UE type and an allow list of UEs permitted to connect to a base station.

In some implementations, the UE location may be determined based on a timing advance signal, on a global positioning system (GPS) sensor of the UE, on an Internet Protocol (IP) address of the UE, on user permission from a user of the UE, on a restricted UE location tracking mechanism, or on an allow list of a base station of the telecommunications network.

The geofencing logic may define or utilize a geofence, and the geofence may be specific to a base station, a cell site, a group of cell sites, or a tracking area code. The location determination mechanism used may be related to the specificity of the geofence that is chosen, and the specificity of the geofence may in turn be related to which geofencing mechanism(s) are available. In some implementations, use outside of the geofence may be allowed for a brief time period with, e.g., a message to the user informing the user that the user's plan does not cover use of the UE in the current location (or, alternatively, only covers use of the UE in a specific location (e.g., home, office, etc.)). Also, or instead, some types of use outside of the geofence may be allowed, while others may not.

As used herein, “UE” often refers to a UE that is a FWA special-purpose device or to a UE that is configured to act as a FWA device. Both may be said to have a UE type that is FWA, and “UE” should be taken to refer to a UE having a UE type of FWA unless context suggests otherwise. An example of context suggesting otherwise is when “other UEs” connect to the telecommunications network through the UE with the UE type of FWA.

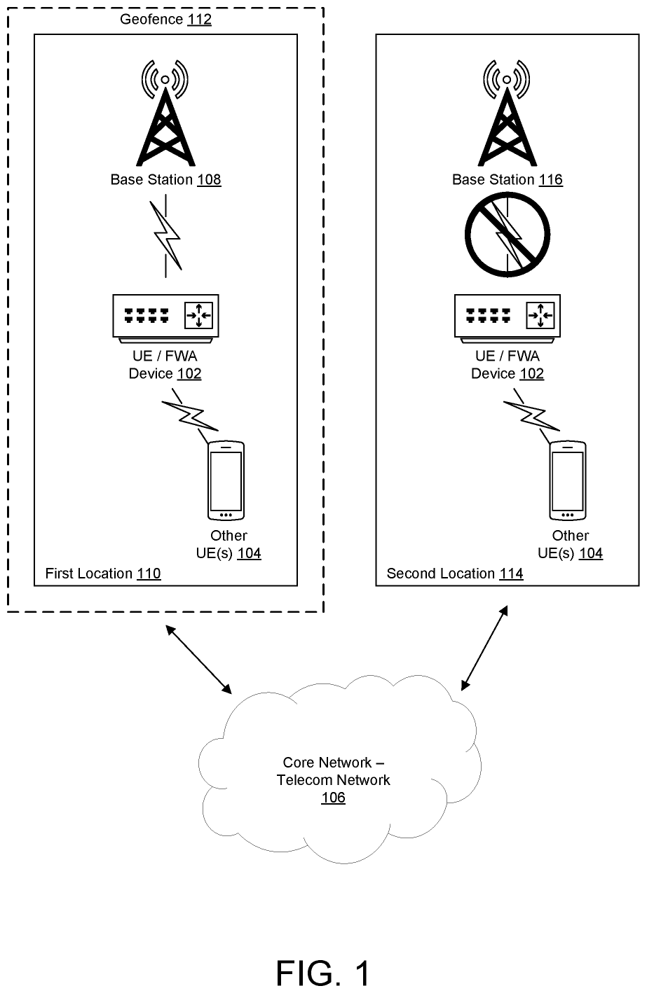

FIG. 1 is an overview diagram of a UE with a UE type of FWA attempting connection to base stations at different locations, the different locations including one location inside a geofence, where connection is allowed, and other locations outside the geofence, where connection is denied. As illustrated, a UE 102 with a UE type of FWA (also referred to herein as a FWA device 102) may provide connectivity for other UE(s) 104 to a telecommunications network 106. The UE 102 may connect to the telecommunications network 106 through one of its base stations 108 at a first location 110. The base station 108 in turn connects to a core network of the telecommunications network 106. As shown in FIG. 1, the first location 110 may be within a geofence 112 defined by or used by geofencing logic of the base station 108, UE 102, or both. At a different moment in time, the UE 102 may be in a second location 114 and, while in the second location 114, attempt to connect to a base station 116 of the telecommunications network 106. Because the second location 114 is not within the geofence 112, the connection between the UE 102 and base station 116 is denied.

In various examples, the UE 102 is a specific-purpose FWA device or a general-purpose UE configured to serve as a FWA device. In either case, the UE type of the UE 102 is FWA. A UE 102 with a UE type of FWA serves a purpose within its intended physical location that a router for fixed, physical Internet (e.g., Ethernet, cable) serves in its premises: providing wireless access to a data network (Internet) for wireless devices, both in-home appliances and mobile devices within a premises. These devices are represented in FIG. 1 by the “other UE(s) 104.” The UE 102 may use similar protocols and mechanisms for connecting to and disconnecting from base stations (e.g., base stations 108 and 116) as general-purpose UEs (e.g., cellular phones, mobile devices, tablet computers, personal computers (PCs), Internet-of-Things devices, wearable devices, etc.). In some examples, the UE 102 and one of the other UE(s) 104 may be a same category of device (e.g., cellular phones), but the UE 102 may be configured to act as a FWA device. In other examples, the UE 102 is a specific-purpose device that may be provisioned with transceivers, processing resources, memory, etc., that enable the UE 102 to better serve as a FWA device.

In some implementations, the UE 102 may be configured to communicate with the telecommunications network 106, other UE(s) 104, or both using Fourth Generation (4G), Fifth Generation (5G), Sixth Generation (6G), or any earlier or later generation of radio access technology.

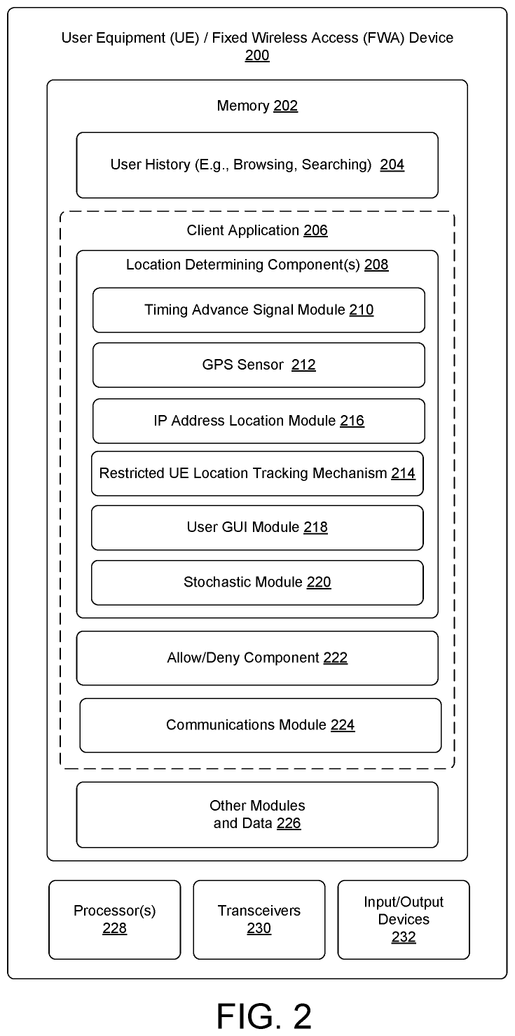

The UE 102 may also include one or more location determining mechanisms. The UE 102 may be configured to determine a timing advance signal that indicates a location of the UE 102 to a base station that receives the timing advance signal. The UE 102 may also include a GPS sensor that determines the UE location. The UE 102 may be able to determine a change of its IP address and to indicate a change of UE location based on the change of IP address. Also or instead, the UE may have a restricted UE location tracking mechanism (e.g., a mechanism used to track location for emergency purposes) useable with user permission. Further, the UE 102 may be configured to determine a location based on user history (behavior of users of the UE 102, of the other UE(s) 104, or of both). Further, the UE 102 may be configured to provide any or all of these UE locations to a base station or, alternately, to use the location and configuration information of the UE 102 to allow or deny an attempt to connect to the telecommunications network 106. An example UE 102 is illustrated in FIG. 2 and described below in detail with reference to that figure.

In various implementations, the other UE(s) 104 may be cellular phones, mobile devices, tablet computers, PCs, Internet-of-Things devices, wearable devices, etc. that connect to the telecommunications network 106 through the UE 102. Any device capable of wireless communication across licensed spectrum, unlicensed spectrum, or both may be another UE 104.

In further implementations, the telecommunications network 106 may include both the core network and the base stations 108 and 116. The core network may be a 5G core network, a core network of any earlier or later generation, or a converged core network with nodes from multiple generations of core networks. A core network node of the telecommunications network 106 may provide instructions to a base station 108 or 116 of the telecommunications network 106 to detach or de-register from the UE 102 in response to a determination that the base station 108 or 116 does not support the FWA UE type, a determination that the UE 102 is not on an allow list for the base station 108 or 116, or a determination that a UE location is not within a geofence 112. Such determinations may be performed in part by the core network node.

In some implementations, the base station 108 and 116 may each be any sort of base station, such as a gNode B (gNB) or a base station of an earlier or later radio access technology. The base stations 108 and 116 may each be part of a cell site, and that cell site may have multiple base stations. The cell site may also be part of a tracking area code having multiple cell sites.

Each of base station 108 and 116 may also have an allow/deny component, including geofencing logic, to determine whether a location reported by UE 102 is within a geofence 112 and to allow or deny connection to the telecommunications network 106 based on whether the location is within the geofence. The geofence 112 may be very specific, allowing access in a home but not in a neighbor's home. Such a specific geofence 112 may be applied through use of timing advance signals, with the UE 102 reporting its timing advance signal and the base station 108 or 116 using that timing advance signal to determine whether the UE 102 is within a geofence. The geofence 112 may instead be broader, encompassing a cell site or multiple cell sites and the areas defined by their ranges. Such a geofence may be applied through timing advance signals, GPS coordinates, or a location from a restricted UE location tracking mechanism. With a geofence 112 encompassing a tracking area code or larger area, a location change determination based on IP addresses or a location determined based on stochastic analysis may suffice.

The allow/deny component of the base station 108 or 116 may also be configured to simply deny the connection request if the UE type of the UE 102 is FWA. Or even if it accepts connections for some UEs 102 of UE type FWA, the base station 108 or 116 may only accept connection for UEs 102 on an allow list received, e.g., from the telecommunications network 106.

As shown in FIG. 1, the UE 102 is within the geofence 112 when at the first location 110 and trying to connect to the base station 108. At some other point in time, the UE 102 may instead be at a second location 114 outside of the geofence 112. Base the UE 102 is outside of the geofence 112, the base station 116 denies a connection attempt from the UE 102. The first location 110 and second location 114 may be as close as neighboring houses or may be as far away as different cities, states, or countries.

FIG. 2 is a schematic diagram of a UE having a UE type of FWA, the UE having one or more components for determining a UE location, for communicating with a base station to establish a connection through the base station to a telecommunications network, and for communicating with other UEs that are using the UE as a FWA device for connecting to the telecommunications network. As shown, the UE 200 includes a memory 202 storing user history 204, a client application 206, location determining components 208 (including timing advance signal module 210, GPS sensor 212, IP address location module 216, restricted UE location tracking mechanism 214, user graphic user interface (GUI) module 218, stochastic module 220, etc.), allow/deny component 222, communications module 224, and other modules and data 226. The UE 200 also includes processor(s) 228, transceivers 230, and input/output devices 232. In various implementations, the UE 200 may be an example of the UE 102 with the UE type of FWA.

In various examples, the memory 202 can include system memory, which may be volatile (such as RAM), non-volatile (such as ROM, flash memory, etc.) or some combination of the two. The memory 302 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 202 can include one or more software or firmware elements, such as computer-readable instructions that are executable by the one or more processors 228. For example, the memory 302 can store computer-executable instructions associated with modules and data 204-226.

In various implementations, the memory 202 can store a user history 204 (such as browsing and searching activity). The user history 204 may include activities performed using applications or components of UE 200 (or UE 102), applications or components of other UE(s) 104, when those other UE(s) 104 are connected to UE 200 (or UE 102), or both.

FIG. 2 shows the client application 206 stored in memory 202 as a dotted line. This representation is to recognize that the components shown within the client application 206 may instead be outside of it, but within memory 202. The particular components/features of the client application 206 may vary from implementation to implementation. In some examples, the client application 206 performs the determining (e.g., with location determining component(s) 208) and either informs the telecommunications network 106 of the UE location, the UE type, and the UE identifier or performs the allowing or denying itself.

In various implementations, the UE 200 can have any number of location determining component(s) 208 in memory 202. These can include timing advance signal module 210, GPS sensor 212, IP address location module 216, restricted UE location tracking mechanism 214, user graphic user interface (GUI) module 218, and/or stochastic module 220. The timing advance signal module 210 is configured with a timer to report, to a base station, a timing advance signal at some periodicity set by the timer. When used with information maintained by the base station, the base station can determine the UE location of UE 200. The GPS sensor 212 may be a physical component of UE 200, a software component in memory 202, or a combination of the two that determines GPS coordinates (latitude and longitude) of the UE 200. The client application 206 or a communications module 224 may report the GPS coordinates to the base station. The IP address location module 216 can track a most recent IP address of the UE 200, check a current IP address of the UE 200, and determine whether the IP addresses differ, either entirely or in a part of an IP address which may be indicative of a UE location. If there is a difference, the client application 206 or communications module 224 can report that there has been a location change to the base station. The restricted UE location tracking mechanism 214 may be a mechanism used for tracking UE location for emergency purposes (e.g., e911) and, with user consent, it can be used to track UE location for geofencing purposes. The user GUI module 218 may generate GUIs, including one requesting user consent for UE location tracking, for display on user devices (e.g., other UE(s) 104). The stochastic module 220 may make use of the user history 204 and machine learning techniques to determine associations of browsing and searching with locations and whether recent user history indicates a change of UE location. If it does, either that UE location or an indication that the location has changed may be reported to the base station.

In some implementations, the allow/deny component 222 can prevent the UE 102 from transmitting a connection request to a base station or allow such a request to proceed. It may do so based on information/configuration stored on the UE 102, such as a geofence specification, that is compared with a determined location. If there is a discrepancy, the connection may be denied. Alternatively, it may be allowed for a period of time and then denied, with the user GUI module 218 providing a message to a user that the UE 102 is outside the geofence and the connection will be permitted for only a specific time period.

The communications module 224 may establish and maintain connections with base stations (e.g. base stations 108 and 116) and with other UE(s) (e.g., other UE(s) 104). It may also, as part of client application 206 or separately from it, communicate a determined location or indication of location change or timing advance signal to the base station.

The other modules and data 226 can include a platform, operating system, and applications, and data utilized by the platform, operating system, and applications. Further, the modules and data 204-226 can implement any of the functionality for the UE 102 described and illustrated herein.

In various examples, the processor(s) 228 can be a central processing unit (CPU), a graphics processing unit (GPU), or both CPU and GPU, or any other type of processing unit. Each of the one or more processor(s) 228 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 228 may also be responsible for executing all computer applications stored in the memory 202, which can be associated with types of volatile (RAM) and/or nonvolatile (ROM) memory.

The transceivers 230 can include modems, interfaces, antennas, Ethernet ports, cable interface components, and/or other components that perform or assist in exchanging wireless communications, wired communications, or both.

While the computing device need not include input/output devices 232, in some implementations it may include one, some, or all of these. For example, the input/output devices 232 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 232 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 232 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

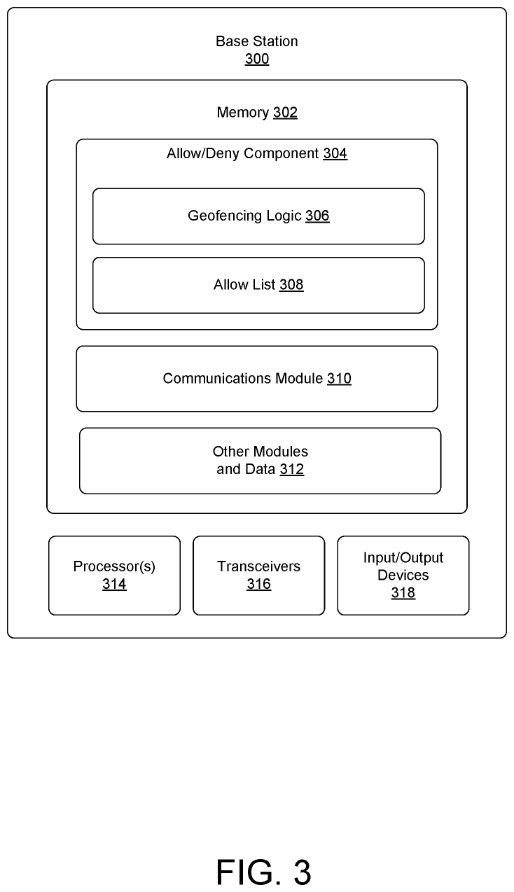

FIG. 3 is a schematic diagram of a base station with geofencing logic to implement a geofence for a UE, where the UE type is FWA, and with components for allowing or denying connection of UEs to the base station based on the geofencing logic and for communicating with the UEs and a core network. As shown, the base station 300 includes a memory 302 storing an allow/deny component 304 that includes geofencing logic 306 and/or an allow list 308, a communications module 310, and other modules and data 312. The base station further includes processor(s) 314, transceivers 316, and input/output devices 318.

In various examples, the memory 302 can include system memory, which may be volatile (such as RAM), non-volatile (such as ROM, flash memory, etc.) or some combination of the two. The memory 302 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 302 can include one or more software or firmware elements, such as computer-readable instructions that are executable by the one or more processors 314. For example, the memory 302 can store computer-executable instructions associated with modules and data 304-312.

The base station 300 includes an allow/deny component 304 to determine whether to allow or deny a connection request from a UE with a UE type of FWA, such as UE 102 or UE 200. The allow/deny component 304 includes geofencing logic 306 and an allow list 308. The geofencing logic 306 may utilize or specify a geofence for use by the allow/deny component 304. For example, the geofence may be specific to a base station, a cell site, a group of cell sites, or a tracking area code. The geofencing logic 306 may compare a location received from a UE 102 or UE 200 to the geofence to determine whether the location is in the geofence. If the location is in the geofence, the allow/deny component 304 may allow the connection from the UE 102 or UE 200. If the location is outside the geofence, the allow/deny component 304 may deny the connection or allow it for a limited time, along with a message that the allowance is for a limited time.

The allow/deny component 304 may also participate in determining the location of the UE 102 or UE 200. For example, the base station 300 may receive a timing advance signal from the UE 102 or UE 200 and, based on that signal and the location of the base station (which may be known by the base station 300), the allow/deny component 304 may determine the location of the UE 102 or UE 200 for use by the geofencing logic 306.

With some location information from the UE 102 or UE 200, such as an indication that a location has changed, the geofencing logic 306 may simply determine that the indication of location change means that the UE 102 or UE 200 is outside the geofence and proceed with denying the connection request or allowing it temporarily.

In some implementations, the allow/deny component 304 may determine whether to allow or deny the connection request from the UE 102 or UE 200 based on the UE type and UE identifier without consideration of UE location. Some base stations 300 may be configured to deny all requests from UEs with a UE type of FWA; others may be configured to deny all requests from UEs with a UE type of FWA except for requests where the UE identifier is present in the allow list 308. The allow list 308 may be received from a core network node of the telecommunications network 106 and may list a limited set of UEs 102 or 200 that have homes/offices within a vicinity of the base station 300 receiving the allow list 308. So in such implementations, if the base station 300 supports the FWA UE type and if the UE identifier of the UE 102 or 200 is on the allow list 308, the allow/deny component 304 may allow the request. Otherwise, if either condition is negative (e.g., does not support FWA UE type of UE identifier is not on allow list 308), allow/deny component 304 denies the connection request or allows it temporarily.

In various implementations, the base station 300 may have a communications module 310 for establishing connections and data flows with a UE 102, a UE 200, another UE 104, or a core network node of the telecommunications network 106. The communications module 310 may, in some implementations, receive the connection requests and respond with allowing or denying the requests. It may also receive instructions from the telecommunications network 106 to detach or de-register a UE 102 or UE 200 when the core network is involved in performing some or all of the operations of the base station 300. It may also receive an allow list 308 from the core network via the communications module 310.

The other modules and data 312 can include a platform, operating system, and applications, and data utilized by the platform, operating system, and applications. Further, the other modules and data 312 can implement any of the functionality for base station 108 or 116.

In various examples, the processor(s) 314 can be a central processing unit (CPU), a graphics processing unit (GPU), or both CPU and GPU, or any other type of processing unit. Each of the one or more processor(s) 314 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 314 may also be responsible for executing all computer applications stored in the memory 302, which can be associated with types of volatile (RAM) and/or nonvolatile (ROM) memory.

The transceivers 316 can include modems, interfaces, antennas, Ethernet ports, cable interface components, and/or other components that perform or assist in exchanging wireless communications, wired communications, or both.

While the computing device need not include input/output devices 318, in some implementations it may include one, some, or all of these. For example, the input/output devices 318 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 318 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 318 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

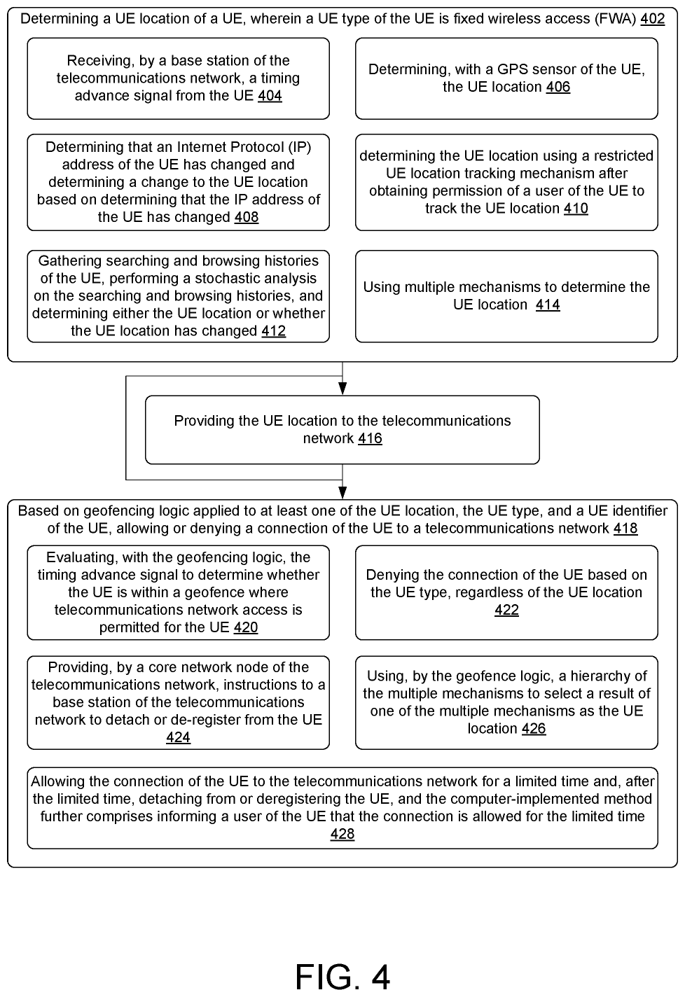

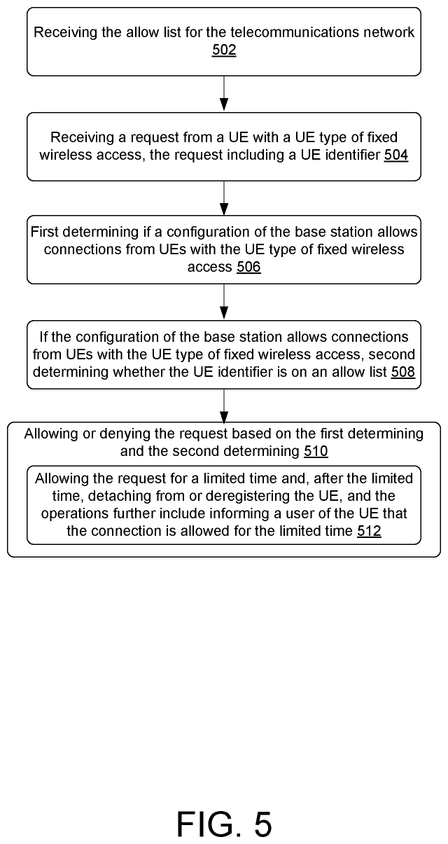

FIGS. 4 and 5 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 4 is a flow diagram of an illustrative process for allowing or denying a connection between a UE and a base station based on at least one of a UE location, a UE identifier, or a UE type, where the UE type is FWA.

As illustrated at 402, a device determines a UE location of a UE, wherein a UE type of the UE is FWA. The device may be the UE itself, a base station, or include both the UE and base station determining the UE location, independently or cooperatively.

At 404, the determining includes receiving, by a base station of the telecommunications network, a timing advance signal from the UE.

At 406, the determining includes determining, with a GPS sensor of the UE, the UE location.

At 408, the determining includes determining that an IP address of the UE has changed and determining a change to the UE location based on determining that the IP address of the UE has changed.

At 410, the determining includes determining the UE location using a restricted UE location tracking mechanism after obtaining permission of a user of the UE to track the UE location.

At 412, the determining includes gathering searching and browsing histories of the UE, performing a stochastic analysis on the searching and browsing histories, and determining either the UE location or whether the UE location has changed.

At 414, the determining includes using multiple mechanisms to determine the UE location.

At 416, when the device performing the determining of the UE location is the UE itself, the UE may provide the UE location to the telecommunications network (e.g., to a base station of the telecommunications network).

At 418, based on geofencing logic applied to at least one of the UE location, the UE type, and a UE identifier of the UE, a device allows or denies a connection of the UE to a telecommunications network. The device may be the UE itself, the base station, or both the UE and the base station, acting independently or cooperatively. The geofencing logic defines or utilizes a geofence, and the geofence is specific to a base station, a cell site, a group of cell sites, or a tracking area code.

At 420, the allowing or denying includes evaluating, with the geofencing logic, the timing advance signal to determine whether the UE is within a geofence where telecommunications network access is permitted for the UE.

At 422, the allowing or denying comprises denying the connection of the UE based on the UE type, regardless of the UE location.

At 424, the allowing or denying comprises a core network node of the telecommunications network providing instructions to a base station of the telecommunications network to detach or de-register from the UE.

At 426, when allowing or denying, the geofence logic uses a hierarchy of the multiple mechanisms to select a result of one of the multiple mechanisms as the UE location.

At 428, the allowing or denying includes allowing the connection of the UE to the telecommunications network for a limited time and, after the limited time, detaching from or deregistering the UE. A user of the UE may also be informed that the connection is allowed for the limited time.

In various implementations, the UE includes a client application, and the client application performs the determining and either informs the telecommunications network of the UE location, the UE type, and the UE identifier or performs the allowing or denying itself.

FIG. 5 is a flow diagram of an illustrative process for allowing or denying a connection between a UE and a base station based on a UE type, where the UE type is FWA, and an allow list of UEs permitted to connect to the base station.

As illustrated at 502, a base station of a telecommunications network may receive the allow list for the telecommunications network. This receiving may occur before, during, or after any of the other operations shown in FIG. 5 and may occur repeatedly.

At 504, the base station receives a request from a UE with a UE type of FWA, the request including a UE identifier.

At 506, the base station first determines if a configuration of the base station allows connections from UEs with the UE type of FWA.

At 508, if the configuration of the base station allows connections from UEs with the UE type of FWA, the base station second determines whether the UE identifier is on an allow list.

At 510, the base station allows or denies the request based on the first determining and the second determining. The allowing or denying may be performed by geofencing logic that defines or utilizes a geofence, and the geofence may be specific to the base station, a cell site, a group of cell sites, or a tracking area code.

At 512, the allowing or denying include allowing the request for a limited time and, after the limited time, detaching from or deregistering the UE. A user of the UE may be informed that the connection is allowed for the limited time.

Although features and/or methodological acts are described above, it is to be understood that the appended claims are not necessarily limited to those features or acts. Rather, the features and acts described above are disclosed as example forms of implementing the claims.

What is claimed is:

1. A computer-implemented method comprising:
determining a user equipment (UE) location of a UE, wherein a UE type of the UE is fixed wireless access (FWA); and
based on geofencing logic applied to at least one of the UE location, the UE type, and a UE identifier of the UE, allowing or denying a connection of the UE to a telecommunications network.

2. The computer-implemented method of claim 1, wherein the determining includes receiving, by a base station of the telecommunications network, a timing advance signal from the UE, and the allowing or denying includes evaluating, with the geofencing logic, the timing advance signal to determine whether the UE is within a geofence where telecommunications network access is permitted for the UE.

3. The computer-implemented method of claim 1, wherein the determining includes determining, with a global positioning system (GPS) sensor of the UE, the UE location, and the method further comprises providing the UE location to the telecommunications network.

4. The computer-implemented method of claim 1, wherein the determining includes determining that an Internet Protocol (IP) address of the UE has changed and determining a change to the UE location based on determining that the IP address of the UE has changed.

5. The computer-implemented method of claim 1, further comprising obtaining permission of a user of the UE to track the UE location, and the determining includes determining the UE location using a restricted UE location tracking mechanism.

6. The computer-implemented method of claim 1, wherein the determining includes gathering searching and browsing histories of the UE, performing a stochastic analysis on the searching and browsing histories, and determining either the UE location or whether the UE location has changed.

7. The computer-implemented method of claim 1, wherein the allowing or denying comprises denying the connection of the UE based on the UE type, regardless of the UE location.

8. The computer-implemented method of claim 1, wherein the UE includes a client application, and the client application performs the determining and either informs the telecommunications network of the UE location, the UE type, and the UE identifier or performs the allowing or denying itself.

9. The computer-implemented method of claim 1, wherein the allowing or denying comprises a core network node of the telecommunications network providing instructions to a base station of the telecommunications network to detach or de-register from the UE.

10. The computer-implemented method of claim 1, wherein the determining includes using multiple mechanisms to determine the UE location and the geofence logic uses a hierarchy of the multiple mechanisms to select a result of one of the multiple mechanisms as the UE location.

11. The computer-implemented method of claim 1, wherein the determining is performed by the UE, a base station of the telecommunications network, or both.

12. The computer-implemented method of claim 1, wherein the geofencing logic defines or utilizes a geofence, and the geofence is specific to a base station, a cell site, a group of cell sites, or a tracking area code.

13. The computer-implemented method of claim 1, wherein the allowing or denying includes allowing the connection of the UE to the telecommunications network for a limited time and, after the limited time, detaching from or deregistering the UE, and the computer-implemented method further comprises informing a user of the UE that the connection is allowed for the limited time.

14. A base station comprising:
one or more processors; and
a plurality of programming instructions that, when executed by the one or more processors, cause the one or more processors to perform operations including:
receiving a request from a user equipment (UE) with a UE type of fixed wireless access (FWA), the request including a UE identifier;
first determining if a configuration of the base station allows connections from UEs with the UE type of FWA;
if the configuration of the base station allows connections from UEs with the UE type of FWA, second determining whether the UE identifier is on an allow list; and
allowing or denying the request based on the first determining and the second determining.

15. The base station of claim 14, wherein the allowing or denying are performed by geofencing logic that defines or utilizes a geofence, and the geofence is specific to the base station, a cell site, a group of cell sites, or a tracking area code.

16. The base station of claim 14, wherein the operations include receiving the allow list for a telecommunications network that includes the base station.

17. The base station of claim 14, wherein the allowing or denying includes allowing the request for a limited time and, after the limited time, detaching from or deregistering the UE, and the operations further include informing a user of the UE that the connection is allowed for the limited time.

18. A system comprising:
one or more processors; and
a plurality of programming instructions that, when executed by the one or more processors, cause the system to perform operations including:
determining a user equipment (UE) location of a UE, wherein a UE type of the UE is fixed wireless access (FWA); and
based on geofencing logic applied to at least one of the UE location, the UE type, and a UE identifier of the UE, allowing or denying a connection of the UE to a telecommunications network.

19. The system of claim 18, wherein the UE location is determined based on a timing advance signal, on a global positioning system (GPS) sensor of the UE, on an Internet Protocol (IP) address of the UE, on user permission from a user of the UE, on a restricted UE location tracking mechanism, or on an allow list of a base station of the telecommunications network.

20. The system of claim 18, wherein the allowing or denying are performed by geofencing logic that defines or utilizes a geofence, and the geofence is specific to a base station, a cell site, a group of cell sites, or a tracking area code.
